(19) United States
(12) Patent Application Publication
(10) Pub. No.: US 2009/0297831 A1
(43) Pub. Date: Dec. 3, 2009

(54) Printing plate material

(75) Inventor: Takahiro Mori, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Hino-shi, Tokyo (JP)

(21) Appl. No.: 12/448,769

(22) PCT Filed: Dec. 20, 2007
(86) PCT No.: PCT/JP2007/074508

§ 371 Date: Jul. 7, 2009

(30) Foreign Application Priority Data
Jan. 11, 2007 (JP) 2007-003192

(51) Int. Cl. B32B 5/16

(52) U.S. Cl. 428/327

(57) ABSTRACT

A printing plate material, provided with an image forming layer on a substrate, wherein the image forming layer contains following (A1) or (A2): (A1) Polymer particles which are formed by emulsion polymerization utilizing polymerizable monomer having a carboxylic group and polymerizable monomer having an amide group and have a glass transition temperature (Tg) of not lower than 70° C., and (A2) Polymer particles having a core-shell structure formed by emulsion polymerization and the shell of the polymer particles are comprised of polymer which is polymerized by use of polymerizable monomer having a carboxylic group and polymerizable monomer having an amide group and has a glass transition temperature (Tg) of not lower than 70° C.

### FIELD OF THE INVENTION

The present invention relates to a printing plate material and particularly relates to a printing plate material for use in computer to plate (hereinafter, referred to as CTP) systems.

### BACKGROUND OF THE INVENTION

At present, in the field of printing, printing employing a CTP system has come to be popularized in accordance with digitalization of printing image data, and in this printing, a printing plate material for a CTP system which is inexpensive and easy in handling as well as exhibits printing adaptability equal to a conventional so-called PS plate has been required.

Particularly, in recent years, a process-less plate of a general purpose type, as one having direct imaging (hereinafter, referred to as DI) capability requiring no development process by specific chemicals, being applicable to a press provided with this function and having handling convenience equal to a PS plate, has been required.

An infrared laser recording method adopting wavelengths of near infrared to infrared rays is mainly utilized for image formation of a process-less thermal plate. Process-less thermal plates capable of image formation by this method are roughly classified into an abrasion type and an on-press developable thermal fusion image layer type.

An abrasion type includes, for example, those described in JP-A Nos. 8-507727 (hereinafter, JP-A refers to Japanese Patent Publication Open to Public Inspection No.), 6-186750, 6-199064, 7-314934, 10-58636 and 10-244773.

These are, for example, comprised of either a hydrophilic layer or a hydrophobic layer as the front layer being accumulated on a substrate. In the case of the front layer being a hydrophilic layer, the hydrophilic layer is subjected to abrasion after image-wise exposure to be image-wise removed, whereby a hydrophobic layer can be exposed to form an image portion. However, since there is a problem of contamination of the inside of an exposing apparatus due to a scattered substance of the abraded front layer, a special suction device may be required for the exposing apparatus resulting in decreased application for general purpose.

On the other hand, research and development of a printing material, which is capable of image formation without abrasion and requires no processing by a special developer, nor a wipe-off processing, is on the way. For example, listed is a printing plate material for CTP which utilizes a binder of thermoplastic micro-particles and a binder of a water-soluble polymer compound in a heat-sensitive image forming layer and which is capable of development on a press by use of a dampening solution or an ink, as disclosed in Japanese Patent No. 2938397.

In the above-described printing plate material, thermoplastic micro-particles in an image forming layer are fused with the substrate surface or with thermoplastic micro-particles each other by heat generated by an infrared absorbing agent with infrared laser exposure. Thereby, water resistance and peeling strength of an exposed portion in an image forming layer is increased compared to an unexposed portion to generate difference in a removing property on a press, resulting in image formation.

In such a printing material of a thermal fusion type, polymer micro-particles comprising polymerized styrene or acryl are generally utilized as thermoplastic micro-particles. The mean particle size of micro-particles is decreased to increase sensitivity and the mean particle size in the range of less than 150 nm is generally employed, however, on the other hand, there is a tendency of deterioration of on-press developability when the particle size is the smaller. A method to improve on-press developability includes increase of the ratio of water-soluble polymer compound in an image forming layer, however, there is a fear of large deterioration in printing durability when the ratio of a water-soluble polymer compound is increased. Further, there is a problem of large deterioration of on-press developability in the case of a printing plate material being kept under an environment of high temperature or high humidity, even good balance of sensitivity and printing durability is observed immediately after preparation of the printing plate material.

To solve these problems, a printing plate material and/or a printing system in which polymer particles are characterized by containing a structural compound group (including an N atom) selected from a group comprising such as amide, urethane, methacrylonitrile, crotononitrile, vinylidene cyanide, isocytosine, pyrollidone, piperazine, cyano methyl, cyano ethyl, cyano propyl and cyano aryl, and printing durability is improved by decreasing the mean particle size of polymer micro-particles, is proposed (please refer to Patent Document 1).

However, even in such a printing plate material, there were problems that printing durability improvement was still insufficient and on-press developability was sometimes insufficient, particularly deterioration of on-press developability due to storage under an environment of high temperature and high humidity was large.

Further, as another method to improve printing durability, proposed is a method in which a cross-linking agent capable of cross-linking functional groups in a water-soluble-polymer compound in an image forming layer is incorporated in the image forming layer (please refer to Patent Document 2).

However, the above-described method can not avoid a low sensitivity because great energy is required to cross-link water-soluble polymer. There is a problem of such as deterioration of storage stability when a material to accelerate the cross-linking reaction to increase sensitivity is incorporated.

Further, a printing plate material, which is characterized in that polymer micro-particles are provided with a functional group capable of reacting with a functional group existing in other polymer micro-particles or a functional group existing in other component in a heat-sensitive layer, has been proposed (please refer to Patent Document 3).

However, this printing plate material has a problem of insufficient sensitivity and insufficient printing durability at practical exposure energy.

In this way, it has been difficult with a thermal fusion type printing plate material to simultaneously satisfy such as on-press developability, sensitivity, printing durability and storage stability against heat-humidity.

Patent Document 1: Unexamined Japanese Patent Application Publication No. (hereinafter, referred to as JP-A) 2002-251005

Patent Document 2: JP-A 9-171250

Patent Document 3: JP-A 2001-260554

### DISCLOSURE OF THE INVENTION

### Problems to be Solved by the Invention

An object of this invention is to provide a printing plate material for CTP systems which has high sensitivity and is excellent in printing durability and storage stability while retaining satisfactory on-press developability.

### Means to Solve the Problems

The above-described object of this invention can be achieved by the following constitutions.

Item 1. A printing plate material, provided with an image forming layer on a substrate,

wherein the image forming layer contains following (A1) or (A2):
(A1) Polymer particles which are formed by emulsion polymerization utilizing polymerizable monomer having a carboxylic group and polymerizable monomer having an amide group and have a glass transition temperature (Tg) of not lower than 70° C.,
(A2) Polymer particles having a core-shell structure formed by emulsion polymerization and the shell of the polymer particles are comprised of polymer which is polymerized by use of polymerizable monomer having a carboxylic group and polymerizable monomer having an amide group and has a glass transition temperature (Tg) of not lower than 70° C.

Item 2. The printing plate material described in Item 1 above,

wherein a mean particle size of the polymer particles is not less than 30 nm and less than 120 nm.

Item 3. The printing plate material described in Item 1 or 2 above,

wherein the polymer particle has a carbonyl group on a surface, and the image forming layer contains (B) polyhydrazide compound.

Item 4. The printing plate material described in any one of Items 1-3 above,

wherein the polymer particles of (A1) and (A2) are provided with practically no styrene as a polymerizing unit.

Item 5. A printing plate material, provided with an undercoat layer and an image forming layer on a substrate in the order from a substrate side,

wherein the image forming layer contains following (A3) or (A4) and the undercoat layer contains following (B):
(A3) Polymer particles which are formed by emulsion polymerization by use of monomer having a carbonyl group and which have a glass transition temperature (Tg) of not lower than 70° C.,
(A4) Polymer particles which are provided with a core-shell structure formed by emulsion polymerization, wherein the shell is polymerized by use of monomer having a carbonyl group and is comprised of polymer having a glass transition temperature (Tg) of not lower than 70° C.,
(B) Polyhydrazide compound.

Item 6. The printing plate material described in Item 5 above,

wherein the undercoat layer is a hydrophilic layer.

Item 7. The printing plate material described in Item 5 or 6 above,

wherein (B) polyhydrazide compound is water-soluble.

Item 8. The printing plate material described in any one of Items 5-7 above,

wherein the polymer particle having at least one group of a carboxyl group or an amide group on its surface.

Item 9. The printing plate material described in any one of Items 5-8 above,

wherein the polymer particles of (A3) and (A4) are provided with practically no styrene as a polymerizing unit.

Item 10. A printing plate material, provided with an image forming layer and an overcoat layer on a substrate in the order from a substrate side,

wherein the image forming layer contains following (A3) or (A4) and the overcoat layer contains (B):
(A3) Polymer particles which are formed by emulsion polymerization by use of monomer having a carbonyl group and which have a glass transition temperature (Tg) of not lower than 70° C.,
(A4) Polymer particles which are provided with a core-shell structure formed by emulsion polymerization, wherein the shell is polymerized by use of monomer having a carbonyl group and is comprised of polymer having a glass transition temperature (Tg) of not lower than 70° C.,
(B) Polyhydrazide compound.

Item 11. The printing plate material described in Item 10 above,

wherein the polymer particle having at least one group of a carboxyl group and an amide group on its surface.

Item 12. The printing plate material described in Item 10 or 11 above,

wherein the polymer particles of (A3) and (A4) are provided with practically no styrene as a polymerizing unit.

### EFFECTS OF THE INVENTION

The aforesaid constitutions of this invention can provide a printing plate material which has high sensitivity and is excellent in printing durability and storage stability while retaining satisfactory on-press developability.

### DESCRIPTION OF THE PREFERRED EMBODIMENT

In the following, this invention will be detailed.

A printing plate material which is provided with an image forming layer on a substrate, wherein image forming layer contains following (A1) or (A2):

(A1) Polymer particles which are formed by emulsion polymerization utilizing polymerizable monomer having a carboxylic group and polymerizable monomer having an amide group and have a glass transition temperature (Tg) of not lower than 70° C., and
(A2) Polymer particles having a core-shell structure formed by emulsion polymerization and the shell of said polymer particles is comprised of polymer which is polymerized by use of polymerizable monomer having a carboxylic group and polymerizable monomer having an amide group and which has a glass transition temperature (Tg) of not lower than 70° C.

Further, a printing plate material which is provided with an undercoat layer and an image forming layer on a substrate in the order from said substrate side, wherein said image forming layer contains following (A3) or (A4) and said undercoat layer contains (B);

(A3) Polymer particles which are formed by emulsion polymerization by use of monomer having a carbonyl group and which have a glass transition temperature (Tg) of not lower than 70° C.,
(A4) Polymer particles which are provided with a core-shell structure formed by emulsion polymerization, wherein the shell is polymerized by use of monomer having a carbonyl group and is comprised of polymer having a glass transition temperature (Tg) of not lower than 70° C., and
(B) Polyhydrazide compound.

Further, a printing plate material, which is provided with an image forming layer and an overcoat layer on a substrate in the order from said substrate side, wherein said image forming layer contains following (A3) or (A4) and said overcoat layer contains (B):

(A3) Polymer particles which are formed by emulsion polymerization by use of monomer having a carbonyl group and which have a glass transition temperature (Tg) of not lower than 70° C.,
(A4) Polymer particles which are provided with a core-shell structure formed by emulsion polymerization, wherein the shell is polymerized by use of monomer having a carbonyl group and is comprised of polymer having a glass transition temperature (Tg) of not lower than 70° C., and
(B) Polyhydrazide compound.

### (Means 1 to Solve the Problems)

An image forming layer according to means 1 to solve the above-described problems of this invention is a layer to form an image by heat and contains polymer particles of aforesaid (A1) and (A2).

That is, polymer, which is formed by use of polymerizing monomer having a carboxylic group and polymerizing monomer having an amide group and which has a glass transition temperature (Tg) of not lower than 70° C., is utilized as particles of (A1) or as the shell of particles of (A2).

Polymerizing monomer having a carboxyl group according to this invention is a polymerizing monomer substance provided with a carboxyl group. Polymerizing monomer having a carboxyl group includes acrylic acid and methacrylic acid, which are preferably utilized. The content of a polymerizing monomer unit having a carboxyl group against polymer particles is preferably 1-15 weight % of the whole particles.

Polymerizing monomer having an amide group includes such as N-isopropylpropene amide, N,N-dimethylpropene amide, N,N′-methylene diacrylamide, N-methylol acylamide, diacetone acrylamide and diacetone methacrylamide, however, is not limited thereto.

In this invention, diacetone acrylamide or diacetone methacrylamide is specifically preferably utilized. The content of a polymerizing monomer unit having an amide group against polymer particles is preferably 1-15 weight % of the whole particles.

As other polymerizing monomer utilized for polymer particles, those well known in the art can be utilized. For example, such as monomer containing a methylacrylate, methylmethacrylate, butylacrylate, butylmethacrylate, laurylacrylate, laurylmethacrylate, 2-ethylhexylacrylate or ethyleneoxide structure can be preferably utilized.

Further, polymer which has been formed by use of polymerizing monomer having a carboxylic group and polymerizing monomer having an amide group and has a glass transition temperature (Tg) of not lower than 70° C. preferably contains practically no styrene as a monomer unit. Herein, to contain practically no styrene means that the content of a styrene monomer unit against polymer is not more than 5 weight %.

Glass transition temperature (Tg) according to this invention refers to a value determined from the DSC curve obtained by the measurement under a condition to raise temperature at 5° C./min based on DSC method of JISK7121:1987.

Polymer-particles utilized in this invention can be prepared by such as an emulsion polymerization method and a core-shell emulsion polymerization method which are well known in the art. For example, methods described in JP-A Nos. 7-316242, 9-43893 and 2003-201306 can be preferably employed.

The glass transition temperature (Tg) of polymer utilized in particles (A1) or (A2) required to be not lower than 70° C. with respect to storage stability. The Tg can be set to a predetermined value by appropriately adjusting the combination of monomer utilized.

The Tg according to this invention is preferably 70-150° C. and specifically preferably 75-110° C.

The ratio of a shell to the total of core-shell polymer particles of (A2) is preferably not less than 15 weight % and less than 70 weight % and more preferably not less than 25 weight % and less than 50 weight %, with respect to on-press developability and ink affinity.

The mean particle size of polymer particles of (A1) and (A2) is preferably not less than 30 nm and less than 120 nm with respect to printing durability and on-press developability.

A mean particle size referred here indicates a median size determined from particle size distribution which is measured by use of a laser diffraction/scattering particle size analyzer or a dynamic scattering particle size analyzer. As a laser diffraction/scattering particle size analyzer or a dynamic scattering particle size analyzer, preferably utilized is, for example, an analyzer manufactured by Horiba Ltd.

The content of particles of (A1) or (A2) in an image forming layer is preferably 1-95 weight % and specifically preferably 10-75 weight %.

More preferable embodiments of means 1 or 2 to solve the above-described problems include an embodiment in which particles of (A1) and (A2) are provided with a carbonyl group on the surface of particles and an image forming layer contains (B) polyhydrazide compound.

Polymer particles, on the surface of which is provided with a carbonyl group, can be prepared by polymerization utilizing polymerizing monomer having a carbonyl group.

Polymerizing monomer having a carbonyl group includes such as acrolein, diacetone acrylamide, diacetone methacrylamide, acetoacetoxy ethylmethacrylate, formylstyrol and vinyl alkyl ketone having a carbon number of 4-7 (such as vinyl methyl ketone, vinyl ethyl ketone and vinyl butyl ketone), however is not limited thereto.

As polymerizing monomer having a carbonyl group utilizable in this invention, diacetone acrylamide and diacetone methacrylamide are preferably utilized because these are provided with an amide group together.

A polyhydrazide compound is a compound having a plural number of hydrazino groups. A hydrazide compound includes such as oxalic acid dihydrazide, malonic acid dihydrazide, succinic acid dihydrazide, glutaric acid dihydrazide, adipic acid dihydrazide, citric acid dihydrazide, sebacic acid dihydrazide, dodecanoic acid dihydrazide and isophthalic acid dihydrazide.

Further, water-soluble aliphatic hydrazine having a carbon number of 2-4 such as ethylene-1,2-dihydrazine, propylene-1,3-dihydrazine and butylene-1,4-dihydrazine can be also utilized and one or not less than two types thereof may be selected.

Further, tris(2-hydrazinocarbonylethyl)isocyanulate described in JP-A 2002-371069 can be also preferably utilized.

A polyhydrazide compound, in the case of being water-soluble, can be utilized as it is by being dissolved and added into a water-based coating solution. In the case of being water-insoluble, it can be utilized either by adding into a water-based coating solution after having been dispersed as micro-particles having a mean particle size of from 1 to few tens μm or by adding into a coating solution after appropriately having been dissolved in a solvent.

In this invention, a water-soluble polyhydrazide compound is preferably utilized in view of depression of background fogging.

A polyhydrazide compound reacts with a carbonyl group in polymer particles to crosslink polymer particles each other. This is considered to be a reaction which proceeds even at ordinary temperatures; however, since polymer particles are in a state of point contact at ordinary temperatures, strength of the cross-linking is weak to allow on-press development. However, it is considered that when heating by image-wise exposure with such as infrared laser exposure is performed, polymer particles will fuse each other to increase the contact area among particles as well as to increase cross-linking density among polymer particles by a polyhydrazide compound, resulting in increased strength of an image portion, whereby an image portion which cannot be removed at the time of on-press development is formed.

The content of a polyhydrazide compound is preferably 0.1-30 weight % and specifically preferably 1-15 weight % against an image forming layer.

Further, the ratio of a polyhydrazide compound to particles of (A1) and (A2), (polyhydrazide compound/particles of (A1) and (A2) (weight ratio)), is preferably 0.1/99.9-50/50.

(Means 5 to Solve the Problems)

(Particles of (A3), (A4))

An image forming layer according to means 5 to solve the above-described problems of this invention is a layer to form an image and contains above-described polymer particles of (A3) or (A4).

That is, polymer which is prepared by emulsion polymerization by use of monomer having a carbonyl group and has a glass transition temperature (Tg) of not lower than 70° C. is utilized as particles of (A3) or as the shell of particles of (A4).

Particles of (A3) and (A4) utilizing polymer having a carbonyl group can be prepared by polymerization utilizing polymerizing monomer having a carbonyl group.

Polymerizing monomer having a carbonyl group includes such as acrolein, diacetone acrylamide, diacetone methacrylamide, acetoacetoxy ethylmethacrylate, formylstyrol and vinyl alkyl ketone having a carbon number of 4-7 (such as vinyl methyl ketone, vinyl ethyl ketone and vinyl butyl ketone), however is not limited thereto.

As polymerizing monomer having a carbonyl group utilizable in this invention, diacetone acrylamide and diacetone methacrylamide, which are provided with an amide group together, are preferably utilized.

As particles of (A3) or (A4), particles having a carboxyl group or an amide group on the surface are a preferable embodiment.

Particles having a carboxyl group or an amide group on the surface can be prepared by synthesis of polymer having a carbonyl group by use of polymerizing monomer having a carboxyl group or polymerizing monomer having an amide group.

As polymerizing monomer having a carboxyl group and polymerizing monomer having an amide group, monomer similar to those utilized in means 1 to solve the aforesaid problem can be utilized.

As polyhydrazide compound utilized in means 5 to solve the above-described problem, those similar to the above-described polyhydrazide compounds utilized in means 3 to solve the aforesaid problem can be utilized and a water-soluble polyhydrazide compound is a preferable embodiment.

The content of a polyhydrazide compound is preferably 0.1-30 weight % and specifically preferably 1-15 weight %, against an image forming layer.

Further, the ratio of a polyhydrazide compound to particles of (A3) and (A4) (polyhydrazide compound/particles of (A3) and (A4) (weight ratio)) is preferably 0.1/99.9-50/50.

The undercoat layer of above-described constitution 5 is a layer existing between a substrate and an image forming layer and is preferably a hydrophilic layer. A hydrophilic layer is a layer which can be a non-image portion at printing and is provided with a water-retention property.

A hydrophilic layer contains a hydrophilic material. A hydrophilic material includes such as a water-soluble polyhydrazide compound and water-soluble polymer resin. A hydrophilic layer may be either a layer constituted of a hydrophilic material or a layer constituted of a mixture of a hydrophilic material and an inorganic binder such as colloidal silica or silicate.

As a hydrophilic material, such as a water-soluble polyhydrazide compound and a phosphobetaine compound are preferably utilized.

A phosphobetaine compound is a compound having a phosphonic group, which is an anionic group, and a cationic group in a molecule, and for example, polymer containing the following compound as a constituent unit can be preferably utilized.

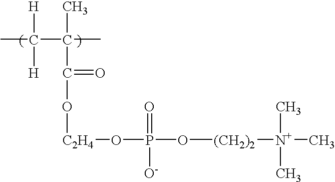

The coating amount of an undercoat layer is preferably 0.001-10 g/m² and specifically preferably 0.01-5 g/m².

(Means 10 to Solve the Problems)

An image forming layer according to means 10 to solve the above-described problem of this invention is a layer to form an image by heating and contains polymer particles of above-described (A3) or (A4).

That is, polymer which is formed by emulsion polymerization utilizing monomer having a carbonyl group and which has a glass transition temperature (Tg) of not lower than 70° C. is utilized as particles of (A3) or as the shell of particles of (A4).

Particles of (A3) and (A4) utilizing polymer having a carbonyl group can be prepared by polymerization utilizing polymerizing monomer having a carbonyl group.

Polymerizing monomer having a carbonyl group includes such as acrolein, diacetone acrylamide, diacetone methacrylamide, acetoacetoxy ethylmethacrylate, formylstyrol and vinyl alkyl ketone having a carbon number of 4-7 (such as vinyl methyl ketone, vinyl ethyl ketone and vinyl butyl ketone), however is not limited thereto.

As polymerizing monomer having a carbonyl group utilizable in this invention, diacetone acrylamide and diacetone methacrylamide, which are provided with an amide group together, are preferably utilized.

As particles of (A3) or (A4), particles having a carboxyl group or an amide group on the surface are a preferable embodiment.

Particles having a carboxyl group or an amide group on the surface can be prepared by synthesis of polymer having a carbonyl group by use of polymerizing monomer having a carboxyl group or polymerizing monomer having an amide group.

As polymerizing monomer having a carboxyl group and as polymerizing monomer having an amide group, monomer similar to those utilized in means 1 to solve the aforesaid problem can be utilized.

As polyhydrazide compound utilized in means 10 to solve the above-described problem, those similar to the above-described polyhydrazide compounds utilized in means 3 to solve the aforesaid problem can be utilized and a water-soluble polyhydrazide compound is a preferable embodiment.

The content of a polyhydrazide compound is preferably 1-100 weight % and specifically preferably 10-100 weight %, against an overcoat layer.

Further, the ratio of a polyhydrazide compound to particles of (A3) and (A4), (polyhydrazide compound/particles of (A3) and (A4) (weight ratio)), is preferably 0.1/99.9-50/50.

An overcoat layer of means 10 to solve the above-described problem is a layer existing on an image forming layer and is preferably water-soluble or water-swelling. An overcoat layer of means 10 to solve the above-described problem is a layer the unexposed portion of which is removed (on-press developed) by damping solution or ink at the time of printing.

In an overcoat layer, such as water-soluble resin (such as polyvinyl alcohol, polyvinyl pyrrolidone, polyacrylic acid, polyacrylic salt and polysaccharides) and water-swelling clay minerals of a layer form can be incorporated in addition to a polyhydrazide compound.

The coating amount of an overcoat layer is preferably 0.001-3 g/m² and specifically preferably 0.1-1 g/m².

An image forming layer according to this invention is preferably contains a thermoplastic substance in addition to the above-described particles according to this invention. And it is preferable to further incorporate a photo-thermal conversion agent, water-soluble salt, a pH controlling agent and a surfactant.

An image forming layer preferably contains a thermoplastic compound as thermoplastic particles in a particle form.

A heat melting material or a heat fusing material is preferably utilized as heat melting particles or heat fusing particles in particle form in combination with particles of this invention.

The above-described heat melting particles, particularly among thermoplastic materials, are particles which have a low viscosity when being melted and are comprised of a material generally classified as wax. As for physical properties, it is preferable that softening point is not lower than 40° C. and not higher than 120° C. and meting point is not lower than 60° C. and not higher than 150° C.; and it is more preferable that softening point is not lower than 40° C. and not higher than 100° C. and meting point is not lower than 60° C. and not higher than 120° C. There is a problem of storage stability in the case of a melting point of lower than 60° C. while ink accepting sensitivity is decreased in the case of a melting point of not lower than 300° C.

Utilizable materials include such as paraffin, polyolefin, polyethylene wax, microcrystalline wax and fatty acid type wax. These have a molecular weight of approximately 800-1,000. Further, it is also possible to introduce a polar group such as a hydroxyl group, an ester group, a carboxyl group, an aldehyde group and a peroxide group by oxidizing these waxes for easier emulsification.

Further, it is also possible to add such as stearoamide, linolenamide, laurylamide, myristylamide, hardened beef tallow fatty acid amide, palmitoamide, oleic acid amide, rice sugar fatty acid amide and coconut fatty acid amide, or methylolized substances of these fatty acid amide, methylene bis-stearoamide and ethylene bissteraloamide into these waxes to decrease a softening point or to improve a working property. Further, cumarone-indene resin, rosin modified phenol resin, terpene modified phenol resin, xylene resin, ketone resin, acrylic resin, ionomer and copolymer of these resins can be also utilized.

Among these, any one of polyethylene, microcrystalline, fatty acid ester and fatty acid is preferably incorporated. These materials can perform image formation of high sensitivity because of a relatively low melting point and a low melt viscosity. Further, these materials can reduce damages at the time of the surface of a printing plate material accepting share and can improve resistance against printing dirt due to such as abrasion, because they have a lubricative property.

Further, heat melting particles are preferably capable of being dispersed in water, and the mean particle size is preferably 0.01-10 μm and more preferably 0.1-3 μm, with respect to such as on-press developability and resolution.

Further, heat melting particles may have compositions varying continuously or may be coated with different materials, depending on the inside and the surface layer.

As for a coating method, such as a microcapsule forming method and a sol-gel method, which are well known in the art, can be utilized.

It is a preferable embodiment that a heat sensitive image forming layer of this invention contains heat melting particles as microcapsules.

The content of heat melting particles is preferably 1-90 weight % and more preferably 5-80 weight %, of the total layer.

Heat melting particles utilized in this invention includes thermoplastic hydrophobic polymer particles, and a softening temperature of polymer micro-particles does not have a specific upper limit, however, is preferably not higher than the decomposition temperature of polymer micro-particles. The weight average molecular weight (Mw) of polymer is preferably in a range of 10,000-1,000,000.

Specific examples of polymer to constitute polymer micro-particles include diene (co)polymers such as polypropylene, polybutadiene, polyisoprene and ethylene-butadiene copolymer; synthetic rubbers such as styrene-butadiene copolymer, methylmethacrylate-butadiene copolymer and acrylonitrile-butadiene copolymer; (meth)acrylic ester such as polymethylmethacrylate, methylmethacrylate-(2-ethylhexylacrylate) copolymer, methylmethacrylate-methacrylic acid copolymer, methylacrylate-(N-methylolacrylamide) copolymer and polyacrylonitrile; (meth)acrylic acid (co)polymer, vinyl ester (copolymer such as polyvinyl acetate, vinyl acetate-vinyl propionate copolymer and vinyl acetate-ethylene copolymer; vinyl acetate-(2-ethylhexyl acrylate) copolymer, polyvinyl chloride, polyvinylidene chloride, polystyrene and copolymer thereof. Among them, (meth)acrylic ester, (meth)acrylic acid (co)polymer, vinyl ester (co)polymer, polystyrene and synthetic rubbers are preferably utilized.

Polymer micro-particles may be those comprising polymer polymerized by any method well known in the art such as an emulsion polymerization method, a suspension polymerization method, a solution polymerization method and a gas-phase polymerization method. A method to prepare micro-particles from polymer polymerized by a solution polymerization method or a gas-phase polymerization method includes a method in which a solution of polymer dissolved in an organic solvent is sprayed into an inert gas and dried to be micro-particles, and a method in which polymer is dissolved in an organic solvent which is immiscible with water and the resulting solution is dispersed in water or a water-basted medium followed by elimination of an organic solvent with distillation to prepare micro-particles. Further, in any method, a surfactant such as sodium lauryl sulfate, sodium dodecylbenzene sulfonate and polyethylene glycol or water soluble resin such as polyvinyl alcohol may be appropriately utilized as a dispersant or a stabilizer at the time of polymerization or micro-particle formation.

Further, heat fusing particles are preferably capable of being dispersed in water, and the mean particle size is preferably 0.01-10 μm and more preferably 0.1-3 μm, with respect to such as on-press developability and resolution.

Further, heat fusing particles may have compositions varying continuously or may be coated with different materials, depending on the inside and the surface layer.

As the coating method, such as a microcapsule forming method and a sol-gel method, which are well known in the art, can be utilized.

It is a specifically preferable embodiment that a heat sensitive image forming layer of this invention contains heat fusing particles as microcapsules.

Microcapsules include, microcapsules including hydrophobic materials which are described in such as JP-A Nos. 2002-2135 and 2002-19317.

Microcapsules preferably have a mean particle size of 1-10 μm, more preferably 0.3-5 μm and furthermore preferably 0.5-3 μm.

The thickness of the wall of microcapsules is preferably 1/100-⅕ and more preferably 1/50- 1/10, of the diameter.

The content of microcapsules is 5-100 weight %, preferably 20-95 weight % and more preferably 40-90 weight %, of the whole heat sensitive image forming layer.

As a material to be a wall material of microcapsules and a manufacturing method of micro-particles, materials and methods well known in the art can be utilized. For example, materials and manufacturing methods described in “New Edition Microcapsule, Manufacturing Method•Characteristics•Application” (by Tamotsu Kondo, Shinjyun Koishi/published Sankyo Publishing Co., Ltd.) or being referred to in the reference literatures can be utilized.

A photo-thermal conversion agent is a material capable of forming an image on an image forming layer by converting exposure light into heat, and a photo-thermal conversion agent includes the following dye and pigment.

Dye includes organic compounds such as cyanine type dye croconium type dye, polymethine type dye, azulenium type dye, squalium type dye, thiopyrilium type dye, naphthoquinone type dye and anthraquinone dye, which is general infrared absorptive dye; and organo-metallic complexes such as a phthalocyanine type, a naphthalocyanine type, an azo type, a thioamide type, a dithiole type and an indoaniline type. Specifically, listed are compounds described in such as JP-A Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These can be utilized alone or in combination of at least two types.

Further, compounds described in JP-A Nos. 11-240270, 11-265062, 2000-309174, 2002-49147, 2001-162965, 2002-144750 and 2001-219667 can be also preferably utilized.

Pigment includes such as carbon, graphite, metal and metal oxide.

As carbon, specifically preferably utilized are furnace black and acetylene black. The particle size (d50) is not more than 100 nm and furthermore preferably not more than 50 nm.

As graphite, micro-particles having a particle size of not more than 0.5 μm, preferably not more than 100 nm and more preferably not more than 50 nm are utilized.

As metal, any metal micro-particles having a particle size of not more than 0.5 μm, preferably not more than 100 nm and furthermore preferably not more than 50 nm can be utilized. The form may be any one of a spherical form, a sheet form or a needle form. Specifically preferable are colloidal micro-particles (such as Ag and Au).

As metal compounds, materials exhibiting black color in a visible light region or materials themselves having conductivity or being semi-conductive can be utilized.

It is a preferable embodiment that an image forming layer according to this invention contains a water-soluble compound.

A water-soluble compound refers to a compound not less than 0.1 g of which is dissolved in 100 g of water at 25° C. and preferably a compound not less than 1 g of which is dissolved in 100 g of water.

The content of a water-soluble compound in an image forming layer is 1-40 weight %, preferably 5-30 weight % and more preferably 10-25 weight %, with respect to on-press developability.

Specific examples of a water-soluble compound include the following, however, are not limited thereto.

Listed are glycols such as ethylene glycol, diethylene glycol, triethylene glycol, propylene glycol, dipropylene glycol and tripropylene glycol and ether or ester derivatives thereof; polyhydroxides such as glycerin and pentaerythritol; organic amines such as triethanolamine, diethanolamine and monoethanolamine and salt thereof; quaternary ammonium salt such as tetraethylammonium bromide; organic sulfonic acids such as toluene sulfonate and benzene sulfonate and salt thereof; organic phosphonic acids such as phenylphosphonate and salt thereof; organic carboxylic acids such as tartaric acid, oxalic acid, citric acid, malic acid, butylic acid, gluconic acid and amino acids and salt thereof; phosphate (sodium tertiary phosphate, disodium hydrogenphosphate, sodium dihydrogenphosphate, guanidine phosphate), carbonate (sodium carbonate, guanidine carbonate), other water-soluble organic and inorganic salt; and water-soluble polymer such as polysaccharides, polyethylene oxide, polypropylene oxide, polyvinyl alcohol, polyethylene glycol (PEG), polyvinyl ether, polyacrylic acid, polyaclylate, polyacrylamide, polyvinyl pyrrolidone, polystyrene sulfonic acid and polystyrene sulfonate. Further, listed are conjugate-diene type latex such as styrene-butadiene copolymer latex and methylmethacrylate-butadiene copolymer latex; and water-dispersible latex such as acryl type polymer latex and vinyl type polymer latex.

Further, an image forming layer may contain acid (such as phosphoric acid and acetic acid) or alkali (such as sodium hydroxide, silicate and phosphate) for pH adjustment.

The coating amount of an image forming layer is 0.01-5 g/m², preferably 0.1-3 g/m² and more preferably 0.2-2 g/m².

It is a preferable embodiment that an image forming layer according to this invention is an image forming layer capable of being on-press developable.

An image forming layer which is on-press developable refers to an image forming layer which can form an image capable of printing without any development process after image exposure by an image forming layer to be the non-image portion at printing being removed with a dampening solution or with a dampening solution and printing ink, at the time being supplied to a printing process, that is, at the printing preparation stage.

(Substrate)

As a substrate according to this invention, materials utilized as a substrate of a printing plate, which are well known in the art, can be utilized; and listed are such as a metal plate, plastic film, paper treated with such as polyolefin, and a complex substrate comprising the above-described materials being appropriately pasted up together.

The thickness of a substrate is not specifically limited provided being mountable on a press, however, those having a thickness of 50-500 μm are generally easy to be handled.

As a substrate according to this invention, a metal plate the surface of which has been subjected to a hydrophilicity treatment is preferably utilized.

A metal plate includes such as iron, stainless and aluminum; however, in this invention, aluminum or aluminum alloy is specifically preferable with respect to specific gravity and stiffness, and in addition, those having been subjected to any one of a roughening treatment, an anodic oxidation treatment or a surface hydrophilicity treatment (a so-called grained aluminum plate) are more preferable.

As aluminum alloy utilized as a substrate according to this invention, various types can be utilized, and for example, alloy of metal such as silicone, cupper, manganese, magnesium, chromium, zinc, lead, bismuth, nickel, titanium, sodium and iron with aluminum is utilized.

An aluminum plate utilized as a substrate according to this invention is preferably subjected to a degrease treatment to remove rolling oil on the surface prior to a roughening treatment (a graining treatment). As a degrease treatment, such as a degrease treatment to utilize a solvent such as trichlene and sinner and an emulsion degrease treatment utilizing emulsion such as kessylone and triethanol. Further, in a degrease treatment, an aqueous solution of alkali such as caustic soda can be also utilized. In the case of employing an alkaline aqueous solution such as caustic soda in a degrease treatment, dirt and oxidation film, which cannot be removed only with the above-described degrease treatment, can be also removed. Since smut is generated on the surface of a substrate in the case of employing an alkaline aqueous solution such as caustic soda in a degrease treatment, it is preferable to provide a desmut treatment by immersing the substrate in acid such as phosphoric acid, nitric acid, sulfuric acid and chromic acid or mixed acid thereof. A roughening treatment includes, for example, a mechanical method and a method to perform etching by electrolysis.

A mechanical roughening method utilized is not specifically limited; however, a blush grinding method and a horning grinding method are preferable. A roughening by a blush grinding method can be performed, for example, by rotating a rotary blush employing a blush fur having a diameter of 0.2-0.8 mm and pressing the blush against the substrate surface, while supplying slurry comprising particles of volcano ash which has been uniformly dispersed in water. A roughening by horning grinding can be performed, for example, by uniformly dispersing particles of volcano ash having a diameter of 10-100 μm in water and the dispersion is ejected through a nozzle with pressure application to be collided from inclined direction on the surface of a substrate. Further, for example, roughening can be also performed by pasting up a sheet coated with grinding agent particles having a particle size of 10-100 μm so as to make the presence of particles at an interval of 100-200 μm and a density of 2.5×10³-10×10³ particles/cm² and by transferring the roughening pattern of the sheet with pressure.

It is preferable to immerse the plate in an aqueous solution of acid or alkali after having been roughened by means of the above-described mechanical roughening method to eliminate a grinding agent biting on the surface of a substrate and aluminum dust formed on the surface of a substrate. Such as sulfuric acid, persulfuric acid, fluoric acid, phosphoric acid, nitric acid and hydrochloric acid can be utilized as acid and such as sodium hydroxide or potassium hydroxide is utilized as substrate. Among them, an alkaline aqueous solution such as a sodium hydroxide solution is preferably utilized. The dissolution amount of aluminum on the surface is preferably 0.5-5 g/m². It is preferable to apply the plate with a neutralization treatment by immersion in acid such as phosphoric acid, nitric acid, sulfuric acid and chromic acid or mixed acid thereof, after performing an immersion treatment with an alkaline aqueous solution.

An electrochemical roughening method is also not specifically limited; however, it is preferable to perform electrochemical roughening in an acid electrolytic solution. As an acid electrolytic solution, an acid electrolytic solution generally employed in an electrochemical roughening method can be utilized; however, a hydrochloric acid type or a nitric acid type electrolytic solution is preferably utilized. As for an electrochemical roughening method, methods described, for example, in Examined Japanese Patent Application Publication No. 48-28123, British Patent No. 896,563 and JP-A 53-67507 can be utilized. The roughening method can be performed under application of voltage generally in a range of 1-50 volt; however, preferably the voltage is selected in a range of 10-30 volt. As for the current density, a range of 10-200 A/dm² can be employed; however, it is preferably selected in a range of 50-150 A/dm². As for the quantity of electricity, a range of 100-5,000 C/dm² can be employed; however, it is preferably selected in a range of 100-2,000 C/dm². As for the temperature to practice the roughening method, a range of 10-50° C. can be employed; however, it is preferably selected in a range of 15-45° C.

In the case of performing electrochemical roughening method by use of a nitric acid type electrolytic solution, it can be performed under application of voltage generally in a range of 1-50 volt; however, preferably the voltage is selected in a range of 10-30 volt. As for the current density, a range of 10-200 A/dm² can be employed; however, it is preferably selected in a range of 20-100 A/dm². As for the quantity of electricity, a range of 100-5,000 C/dm² can be employed; however, it is preferably selected in a range of 100-2,000 C/dm². As for the temperature to perform the electrochemical roughening method; a range of 10-50° C. can be employed; however, it is preferably selected in a range of 15-45° C. The nitric acid concentration of an electrolytic solution is preferably 0.1-5 weight %. In the electrolytic solution, such as nitrate, chloride, amines, aldehydes, phosphoric acid, chromic acid, boric acid, acetic acid and oxalic acid can be appropriately incorporated.

In the case of performing electrochemical roughening method by use of a hydrochloric acid type electrolytic solution, it can be performed under application of voltage generally in a range of 1-50 volt; however, preferably the voltage is selected in a range of 2-30 volt. As for the current density, a range of 10-200 A/dm² can be employed; however, it is preferably selected in a range of 50-150 A/dm². As for the quantity of electricity, a range of 100-5,000 C/dm² can be employed; however, it is preferably selected in a range of 100-2,000 C/dm² and more preferably in a range of 200-1,000 C/dm². As for the temperature to perform the electrochemical roughening method; a range of 10-50° C. can be employed; however, it is preferably selected in a range of 15-45° C. The hydrochloric acid concentration of an electrolytic solution is preferably 0.1-5 weight %.

It is preferable to immerse the plate, which has been subjected to roughening treatment by the above-described electrochemical roughening method, in acid or alkaline aqueous solution to remove aluminum dust on the surface. As acid, such as sulfuric acid, persulfuric acid, fluoric acid, phosphoric acid, nitric acid and hydrochloric acid are utilized and as substrate, such as sodium hydroxide and potassium hydroxide are utilized.

Among them, alkaline aqueous solution is preferably utilized and the dissolution amount of aluminum on the surface is preferably 0.5-5 g/m². Further, it is preferable to perform a neutralization treatment by immersion into such as phosphoric acid, nitric acid, sulfuric acid and chromic acid, or mixed acid thereof after an immersion treatment by an alkaline aqueous solution.

A mechanical roughening treatment method and an electrochemical roughening treatment method each may be utilized alone for roughening, or a mechanical roughening treatment method and successively an electrochemical roughening treatment method may be employed for roughening.

An anodic oxidation treatment is preferably applied to the plate after a roughening treatment. An anodic oxidation treatment method utilizable in this invention is not specifically limited and a method well known in the art can be employed. Oxidation film is formed on a substrate by an anodic oxidation treatment. As said anodic oxidation treatment, a method to conduct electrolysis utilizing an aqueous solution containing such as sulfuric acid and/or phosphoric acid at a concentration of 10-50% as an electrolytic solution with a current density of 1-10 A/dm² is preferably employed, in addition to this, listed is a method to conduct electrolysis in sulfuric acid with a high current density which is described in U.S. Pat. No. 1,412,768, a method to conduct electrolysis by use of phosphoric acid which is described in U.S. Pat. No. 3,511,661, and a method to utilize a solution containing one type or at least two types of such as chromic acid, oxalic acid and malonic acid. The coating amount of anodic oxidation formed is suitably 1-50 mg/dm² and preferably 10-40 mg/dm². The coating amount of anodic oxidation can be determined, for example, by immersing an aluminum plate in a chromic phosphate solution (prepared by dissolving 35 ml of a 85% phosphoric acid solution and 20 g of chromium oxide (IV) in 1 L of water) to dissolve the oxidation film and measuring the weight change of before and after film dissolution of the plate.

The substrate having been subjected to an anodic oxidation treatment may be appropriately provided with a sealing treatment. As a sealing treatment, such as hot water treatment, boiling water treatment, water vapor treatment, sodium silicate treatment, dichromate aqueous solution treatment, nitrite treatment and ammonium acetate treatment, which are well known in the art, can be employed.

Further, after these treatments, those coated with water-soluble resin such as the above-described phosphonobetaine compound, polyvinyl sulfonic acid, polymer and copolymer having a sulfonic acid group on the side chain, polyacrylic acid; water-soluble metal salt (for example, zinc borate) or yellow dye, amine salt, as a treatment to provide the aforesaid undercoating layer, are also preferable.

Plastic film utilized as a substrate includes film of such as polyethylene terephthalate, polyethylene naphthalate, polyimide, polyamide, polycarbonate, polysulfon, polyphenylene oxide and cellulose esters.

### EXAMPLES

In the following, this invention will be specifically explained with reference to examples, however, is not limited thereto. Herein, “part(s)” is “weight part(s)” unless otherwise mentioned. Further, numerical values in the tables without a unit represent weight part(s).

(Preparation of Substrate)

A substrate was prepared in the following manner.

[Substrate 1]

An aluminum plate (material 1050, thermal refining H16) having a thickness of 0.24 mm was immersed in a 1 weight % sodium hydroxide aqueous solution at 50° C. to perform dissolution treatment so as to make a dissolution amount of 2 g/m², followed by being washed with water, and the resulting plate was immersed in a 5 weight % nitric acid aqueous solution at 25° C. for 30 seconds to perform neutralization treatment, followed by being washed with water.

Successively, this aluminum plate was subjected to an electrolytic roughening treatment by an electrolytic solution containing 11 g/L of hydrochloric acid, 10 g/L of acetic acid and 8 g/L of aluminum under a condition of a peak current density of 80 A/dm² by use of alternate current of sign waves. At this time, the distance between the electrode and the sample surface was set to 10 mm. The electrolytic roughening treatment was performed by being divided into 8 times, and the treatment quantity of electricity (anode time) per one time was set to 40 C/dm² and the total treatment quantity of electricity (anode time) was set to 320 C/dm². Further, there were provided 3 seconds of an intermission between each treatment.

After electrolytic roughening, the plate was immersed in a 10 weight % phosphoric acid aqueous solution kept at 50° C. to perform etching so as to make a dissolution amount of the surface including smut of 0.65 g/m², and was further washed with water.

Next, the plate, after the surface water after washing having been squeezed, was immersed in a lithium silicate aqueous solution of 0.5 weight % based on a SiO₂ component (LSS45, manufactured by Nissan Chemical Industries, Ltd.) kept at 50° C. for 15 seconds and was washed with water, followed by being dried at 80° C. for 5 minutes, whereby a support was prepared.

Surface form parameter Ra value of the substrate was determined according to the following method. The Ra value was 0.38 μm.

After platinum rhodium having been evaporated on the sample surface at a thickness of 1.5 nm, measurement was performed under a condition of 40 times (measurement range of 111.2 μm×149.7 μm, measurement point of 236×368, resolution of approximately 0.5 μm) by use of Non-contact Three Dimensional Roughness Meter RST Plus manufactured by WYCO Co., Ltd., and the measurement data was processed by inclination correction and filtering of Median Smoothing to eliminate noise to determine Ra value. The measurement was conducted 5 times varying the measuring points and the average was calculated.

[Substrate 2]

The following undercoat layer coating solution A was coated on substrate 1 by use of a wired-bar so as to make a dry coating amount of 20 mg/m², followed by being dried to prepare substrate 2 having an undercoat layer.

| Undercoat Layer Coating Solution A | |
|---|---|
| The following phosphobetaine | 0.30 weight parts |
| compound [1] | |
| Pure water | 99.70 weight parts |

Phosphobetaine compound [1]

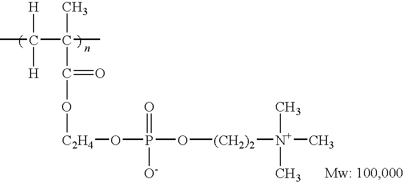

(Preparation of Polymer Particles)

Polymer Particles 1

A 2-litter four-necked flask was charged with 312 weight parts of deionized water and 2.3 weight parts of Newcol 707SF (manufactured by Nippon Nyukazai Co., Ltd., solid content of 30 weight %), being kept at 80° C. after the inside having been replaced with nitrogen, 0.7 weight parts of ammonium persulfate being added immediately before titration of pre-emulsion having the following composition, and the pre-emulsion was titrate over 3 hours.

| | |
|---|---|
| Deionized water | 350 weight parts |
| Diacetone acrylamide | 65 weight parts |
| Acrylic acid | 65 weight parts |
| Styrene | 98 weight parts |
| Methylmethacrylate | 370 weight parts |
| 2-ethylhexyl acrylate | 52 weight parts |
| Newcol 707SF (polyoxyethylene | 60 weight parts |
| polycyclic phenyl ether surfactant) | |
| Ammonium persulfste | 1.2 weight parts |

From 30 minutes after finishing titration, a solution comprising 0.7 weight parts of ammonium persulfate having been dissolved in 7 weight parts of deionized water was titrated over 30 minutes, followed by being kept at 80° C. for further 2 hours, and then pH of the resulting system was adjusted to a range of 8-9 with ammonia water after having been cooled to approximately 50° C., whereby emulsion of polymer particles 1 having a solid content of 50 weight % and a mean particle size of 100 nm was prepared. The Tg of polymer particles 1 was 80° C.

Polymer Particles 2-6: (Core-Shell Type)

Emulsion polymerization was performed so as to make the compositions shown in the table based on the preparation method of example 1 of JP-A 2000-119618. Each polymer particles were prepared as emulsion having a solid content of 30 weight %. Further, the emulsion was prepared so as to have a solvent composition comprising 90 weight % of water to 10 weight % of IPA (isopropanol).

With respect to each polymer particles, a mean particle size, a weight ratio of core/shell and Tg of the core potion and the shell potion are shown in the following table.

TABLE 1

| | | | Polymer particles | | | | | |
|---|---|---|---|---|---|---|---|---|
| Core-shell monomer composition | | | 2 | 3 | 4 | 5 | 6 | 7 |
| Core | Monomer | Styrene | | | 29.0 | | 87.0 | 87.0 |
| portion | type ratio | Methylmetharylate | 89.0 | 89.0 | 60.0 | 89.0 | 2.0 | 2.0 |
| | (weight | 2-ethylhexyl acrylate | 11.0 | 11.0 | 11.0 | 11.0 | 11.0 | 11.0 |
| | part) | | | | | | | |
| | Tg(° C.) | | 73 | 73 | 72 | 73 | 68 | 68 |
| Shell | Monomer | Styrene | | | | | | 10.0 |
| portion | type ratio | Methylmetharylate | 76.0 | 66.0 | 76.0 | 66.0 | 59.5 | 75.0 |
| | (weight | 2-ethylhexyl acrylate | | | 2.0 | 2.0 | 18.5 | 3.0 |
| | part) | Butyl methacrylate | 1.0 | 1.0 | | | | |
| | | Lauryl methacrylate | 1.0 | 1.0 | | | | |
| | | Methacrylic acid | 12.0 | 12.0 | 12.0 | 12.0 | 12.0 | 12.0 |
| | | Acrylamide | | | 10.0 | | 10.0 | |
| | | Diacetone acrylamide | 10.0 | 20.0 | | 10.0 | | |
| | | Methoxypolyethylene | | | | 10.0 | | |
| | | glycol #400 methacrylate | | | | | | |
| | | (manufactured by Shin- | | | | | | |
| | | Nakamura Chemical Co., | | | | | | |
| | | Ltd., NK Ester M-90G) | | | | | | |

| | | | | | | |
|---|---|---|---|---|---|---|
| Tg(° C.) | 105 | 100 | 105 | 77 | 60 | 103 |

| | | | | | | |
|---|---|---|---|---|---|---|
| Core/shell weight ratio | 60/40 | 55/45 | 60/40 | 65/35 | 50/50 | 60/40 |
| Mean particle size (nm) | 50 | 60 | 65 | 80 | 60 | 70 |
| Remarks | Example | Example | Example | Example | Comp. | Comp. |

Comp.: Comparative example

Preparation of Printing Plate Material (1)

Preparation of Image Forming Layer Coating Solution

Each material of the following table was sufficiently mixed with stirring and filtered to prepare each of image forming layer coating solutions (coating solutions 1-7) having a solid content of 5 weight %. As addition order of the materials, pure water was added into a water dispersion of thermoplastic resin particles and then the resulting solution, while being stirred, was titrated with a water-soluble compound aqueous solution to be mixed.

TABLE 2

| | | Coating solution | | | | | | |
|---|---|---|---|---|---|---|---|---|
| Material | | 1 | 2 | 3 | 4 | 5 | 6 | 7 |
| Polymer | Polymer particles 1 emulsion; | 7.50 | | | | | | |
| particles | solid content of 50 weight % | | | | | | | |
| | Polymer particles 2 emulsion; | | 12.50 | | | | | |
| | solid content of 30 weight % | | | | | | | |
| | Polymer particles 3 emulsion; | | | 12.50 | | | | |
| | solid content of 30 weight % | | | | | | | |
| | Polymer particles 4 emulsion; | | | | 12.50 | | | |
| | solid content of 30 weight % | | | | | | | |
| | Polymer particles 5 emulsion; | | | | | 12.50 | | |
| | solid content of 30 weight % | | | | | | | |
| | Polymer particles 6 emulsion; | | | | | | 12.50 | |
| | solid content of 30 weight % | | | | | | | |
| | Polymer particles 7 emulsion; | | | | | | | 12.50 |
| | solid content of 30 weight % | | | | | | | |
| Photo- | Aqueous solution of cyanine | 50 00 | 50.00 | 50.00 | 50.00 | 50.00 | 50.00 | 50.00 |
| thermal | dye 1 (described below); | | | | | | | |
| conversion | solid content of 1 weight % | | | | | | | |
| agent | Water-soluble compound | | | | | | | |
| water- | Aqueous solution of sodium | 1.17 | 1.17 | 1.17 | 1.17 | 1.17 | 1.17 | 1.17 |
| soluble | polyacrylate; Mw = 170,000, | | | | | | | |
| compound | solid content of 30 weight % | | | | | | | |
| | Aqueous solution of guandine | 4.00 | 4.00 | 4.00 | 4.00 | 4.00 | 4.00 | 4.00 |
| | phosphate; solid comtemt of | | | | | | | |
| | 10 weight % | | | | | | | |
| | Pure water | 37.33 | 32.33 | 32.33 | 32.33 | 32.33 | 32.33 | 32.33 |

Cyanine dye 1

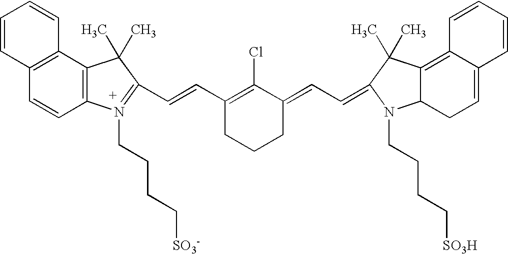

Preparation of Printing Plate Materials 1-7

An image forming layer coating solution comprising the combination of Table 3 was coated on substrate 1 or substrate 2 by use of a wired-bar and dried at 70° C. for 1 minute, as shown in Table 3. The dry coating amount of an image forming layer was adjusted to 0.6 g/m².

Each sample after having been coated with an image forming layer coating solution was subjected to an aging treatment at 50° C. for 24 hours, whereby printing plate materials 1-7 were prepared.

With respect to each printing plate material, those to be evaluated as they are after the aging treatment, those having been kept under an environment of 55° C. and a humidity of less than 206 for 72 hours, and those having been kept under an environment of 40° C. and a humidity of 80% for 72 hours, were prepared, respectively.

[Exposure with Infrared Laser]

Each printing plate material was wound and fixed on an exposure drum. Exposure was performed employing a laser beam having a wavelength of 830 nm and a spot diameter of 18 μm to form an image at 2,400 dpi (dpi represents a dot number per 2.54 cm) and 175 lines. The exposed image includes a solid image and a screen image of 1-99%. Exposure energy was set to 300 mJ/cm².

[Printing Method]

Printing was performed by use of press DAIYA1F-1, manufactured by Mitsubishi Heavy Industries, Ltd., and employing coated paper, damping solution: 2 weight % Astromark 3 (manufactured by Nikken Chemical Laboratory, Co., Ltd.), and ink (manufactured by Toyo Ink Mfg. Co., Ltd., TK Hy-Unity MZ Magenta).

The printing plate material after having been exposed was mounted as it is on a cylinder and 500 sheets of printing was carried out by use of a printing condition and print-start sequence similar to a PS plate.

[Evaluation of On-Press Developability]

How many sheets are required from the start of printing to print a good image was determined. A good image is defined that a density of not less than 1.5 of a solid image is obtained without background fogging and clogging of 90% screen image. In the case of a good image being not obtained even after printing 500 sheets of coated paper, the evaluation rank was defined to be not less than 500 sheets. The result is shown in the table.

[Evaluation of Resistance Against Dirt Due to Abrasion]

On the non-image potion of each printing plate material after having been exposed was applied with abrasion flaws by use of nails and a plastic material. Evaluation was made by observing whether abrasion flows can be recognized as dirt or not on printed matter of the 100th sheet from print start.

The evaluation was based on the following criteria and the results are shown in Table 3. Herein, in the case that background fogging is remained even on the 100th sheet, the evaluation was made by the printed number of printed matter where background fogging was disappeared, and in the case that the degree of abrasion flows could not be distinguished due to remaining background fogging even on the 500th sheet, the evaluation was defined to be indistinguishable due to background fogging.

A: No abrasion flows are observed at all.

B: Abrasion flows are recognized as dirt having a low density.

C: Abrasion flows are clearly recognized as dirt having a high density.

TABLE 3

| | | Image | | | | |
|---|---|---|---|---|---|---|
| | | forming | | | resistance | |
| Printing | | layer | | On-press | against | |
| plate | | coating | Heat | developability | dirt due | |
| material | Substrate | solution | storage | [number of | to | |
| No. | No. | No. | treatment | sheets] | abrasion | Remarks |
| 1 | 2 | 1 | None | 15 | A | Inv. |
| | | | 55° C. | 20 | B | |
| | | | 40° C., 80% | 20 | A | |
| 2 | 2 | 2 | None | 15 | A | Inv. |
| | | | 55° C. | 15 | A | |
| | | | 40° C., 80% | 15 | A | |
| 3 | 1 | 3 | None | 15 | A | Inv. |
| | | | 55° C. | 15 | A | |
| | | | 40° C., 80% | 15 | A | |
| 4 | 2 | 4 | None | 20 | A | Inv. |
| | | | 55° C. | 20 | A | |
| | | | 40° C., 80% | 20 | A | |
| 5 | 2 | 5 | None | 15 | A | Inv. |
| | | | 55° C. | 25 | A | |
| | | | 40° C., 80% | 20 | A | |
| 6 | 2 | 6 | None | 50 | A | Comp. |
| | | | 55° C. | 300 | C | |
| | | | 40° C., 80% | 200 | C | |
| 7 | 2 | 7 | None | 100 | B | Comp. |
| | | | 55° C. | not less | Indistinguishable | |
| | | | | than 500 | due to | |
| | | | | | background | |
| | | | | | fogging | |
| | | | 40° C., 80% | not less | Indistinguishable | |
| | | | | than 500 | due to | |
| | | | | | background | |
| | | | | | fogging | |

Inv.: This invention,
Comp.: Comparison

It is clear from Table 3 that a printing plate material of this invention is excellent in on-press developability and is provided with stable on-press developability and resistance against dirt due to abrasion even after heat storage to be excellent in storage stability.

[Preparation of Printing Plate Material (2)]

Preparation of Image Forming Layer Coating Solution

Each material of the following table was sufficiently mixed with stirring, followed by being filtered, whereby each image forming layer coating solution (coating solutions 8-12) having a solid content of 5 weight % was prepared. As for the addition order of materials, the aqueous dispersion of thermoplastic resin particles was added with pure water and successively the resulting solution was titrated with a water-soluble compound aqueous solution with stirring to be mixed.

TABLE 4

| | | Coating solution | | | | |
|---|---|---|---|---|---|---|
| Material | | 8 | 9 | 10 | 11 | 12 |
| Polymer | Polymer particles 1 emulsion; | 7.30 | | | | |
| particles | solid content of 50 weight % | | | | | |
| | Polymer particles 2 emulsion; | | 12.33 | 12.17 | 12.33 | |
| | solid content of 30 weight % | | | | | |
| | Polymer particles 7 emulsion; | | | | | 12.17 |
| | solid content of 30 weight % | | | | | |
| Photo-thermal | Aqueous solution of cyanine dye | 50.00 | 50.00 | 50.00 | 50.00 | 50.00 |
| conversion agent | 1 (described below); solid | | | | | |
| | content of 1 weight % | | | | | |
| Water-soluble | Sodium polyacrylate aqueous | 1.17 | 1.17 | 1.17 | 1.17 | 1.17 |
| compound | solution; Mw = 170,000, solid | | | | | |
| | content of 30 weight % | | | | | |
| | Guanidine phosphate aqueous | 4.00 | 4.00 | 4.00 | 4.00 | 4.00 |
| | solution; solid content of 10 | | | | | |
| | weight % | | | | | |
| Polyhydrazide | Adipic acid dihydrazide aqueous | | 0.50 | | | |
| compound | solution; solid content of 10 | | | | | |
| | weight % | | | | | |
| | Tris(2- | 1.00 | | 1.00 | | 1.00 |
| | hydrazinocarbonylethyl)isocyanulate | | | | | |
| | aqueous solution; solid | | | | | |
| | content of 10 weight % | | | | | |
| | Dodecanic acid dihydrazide IPA | | | | 5.00 | |
| | suspension; solid content of 1 | | | | | |
| | weight % | | | | | |
| | Pure water | 36.53 | 32.00 | 31.66 | 27.50 | 31.66 |

Preparation of Printing Plate Materials 8-12

An image forming layer coating solution comprising the combinations of Table 5 was coated on the substrates shown in Table 5 by use of a wired-bar and dried at 70° C. for 1 minute. The dry coating amount of an image forming layer was adjusted to 0.6 g/m².

Each sample after having been coated with an image forming layer coating solution was subjected to an aging treatment at 50° C. for 24 hours, whereby printing plate materials 8-12 were prepared.

Preparation of Printing Plate Material 13

Image forming layer coating solution 2 was coated on substrate 2 and dried similar to printing plate material 2.

Next, overcoat layer 1 coating solution described below was coated on the image forming layer by use of a wired-bar and dried at 70° C. for 45 seconds. The dry coating amount of an overcoat layer was adjusted to 20 mg/m².

This was subjected to an aging treatment at 50° C. for 24 hours to prepare printing plate material 13.

Overcoat Layer 1 Coating Solution:

0.3 weight % aqueous solution of tris(2-hydrazinocarbonylethyl)isocyanulate

Preparation of Printing Plate Material 14

Printing plate material 14 was prepared in a similar manner to printing plate material 13 except that following overcoat layer 2 coating solution was utilized instead of overcoat layer 1.

Overcoat Layer 2 Coating Solution

An water-based coating solution having a solid content of 1 weight % which is comprised of polymer particles 2 and tris(2-hydrazinocarbonylethyl)isocyanulate being mixed at a ratio of 90/10 based on the solid content

[Exposure with Infrared Laser]

The exposure was performed in a similar manner to the aforesaid example.

[Printing Method]

Printing was performed by use of press DAIYA1F-1, manufactured by Mitsubishi Heavy Industries, Ltd., and employing printing paper: wood free paper (Shiraoi), damping solution: 2 weight % Astromark 3 (manufactured by Nikken Chemical Laboratory, Co., Ltd.), and ink (manufactured by Toyo Ink Mfg. Co., Ltd., TK Hy-Unity Neo MZ Magenta).

The printing plate material after having been exposed was mounted as it is on a cylinder and 20,000 sheets of printing was carried out by use of a printing condition and print-start sequence similar to a PS plate. Powder (Nikkaryko Coat Type, manufactured by Nikka Ltd.) was sprayed at the time of printing.

Next, printing on the back surface of the printing paper one surface of which having been printed was successively performed to make 40,000 sheets of printed matter as the total of front and back surfaces.

[Evaluation of On-Press Developability]

The evaluation was performed in a similar manner to the aforesaid example.

[Evaluation of Printing Durability]

Printed matter was sampled after every 1,000 sheets printing to confirm the image deterioration degree of the 3% screen image portion and the solid image portion. A point of time when lack of a screen dot in the 3% screen image portion was recognized, or a point of time when scratch in the solid image portion was visually recognized, was defined as the end point of printing and the number of printed sheets at the point was defined as the number of sheets of printing durability. Samples in which lack of a screen dot in the 3% screen image portion or scratch in the solid image portion was not recognized even at printing of 40,000 sheets was defined to have a printing durability of not less than 40,0000. The result is shown in Table 5.

TABLE 5

| | | | Overcoat | | | |
|---|---|---|---|---|---|---|
| Printing | | Image forming | layer | On-press | Printing | |
| plate | | layer | coating | developability | Durability | |
| material | Substrate | coating | solution | [number of | [number of | |
| No. | No. | solution No. | No. | sheets] | sheets] | Remarks |
| 8 | 2 | 8 | None | 15 | 35000 | Inv. |
| 9 | 2 | 9 | None | 15 | Not less | Inv. |
| | | | | | than 40,000 | |
| 10 | 2 | 10 | None | 15 | Not less | Inv. |
| | | | | | than 40,000 | |
| 11 | 1 | 11 | None | 20 | Not less | Inv. |
| | | | | | than 40,000 | |
| 12 | 1 | 12 | None | 100 | 28000 | Comp. |
| 13 | 2 | 2 | 1 | 15 | Not less | Inv. |
| | | | | | than 40,000 | |
| 14 | 2 | 2 | 2 | 15 | Not less | Inv. |
| | | | | | than 40,000 | |

Inv.: This invention,
Comp.: Comparison

It is clear from Table 5 that printing materials of this invention are excellent in on-press developability as well as in printing durability.

Preparation of Printing Plate Material (3)

Preparation of Dispersion of Metal Oxide Particles Having Photo-Thermal Conversion Ability

Dispersion 1

The following materials were dispersed by use of a sand grinder at 1,500 rpm for 2 hours. As a dispersion medium, zirconia beads of 1 mmφ were employed. After dispersion, beads were removed from the system, which was filtered to prepare dispersion 1 having a solid content of 50 weight %. Dispersion 1 is approximately in a state of being dispersed to primary particles.

Dispersion 1 composition (a numerical value in the table without description of a unit indicates weight part(s))

TABLE 6

| Material | Content |
|---|---|
| Black iron oxide: ABL-207 (manufactured by Titan | 49.00 |
| Kogyo, Ltd., true specific gravity of approximately | |
| 5.0 g/cm³, octahedral form, mean particle size: 0.2 | |
| μm, specific surface area: 6.7 m²/g, Hc: 9.95 kA/m, | |
| σₛ: 85.7 Am²/kg, σᵣ/σₛ: 0.112) | |
| Layered mineral particles | 15.00 |
| Montmorillonite: Mineral colloid MO (manufactured | |
| by Southern Clay Products, Ltd., mean particle size | |
| of approximately 0.1 μm) was strongly stirred by a | |
| homogenizer to be water-swelling gel of 5 weight % | |
| 10 weight % aqueous solution of trisodium | 2.50 |
| phosphate•12 water (Kanto Chemical Co., Inc.) | |
| Pure water | 33.50 |

Dispersion 2

Dispersion 2 was prepared in a similar manner to dispersion 1 except that ETB-300 (manufactured by Titan Kogyo, Ltd., mean particle size of 0.5 μm) which is complex metal oxide of a Fe—Ti type was utilized in stead of black iron oxide: ABL-207. Dispersion 2 was also one having been dispersed to primary particles.

Preparation of Hydrophilic Layer Coating Solution

After the materials among those in the following table except a surfactant had been sufficiently mixing dispersed by use of a homogenizer, the resulting system was further added with a surfactant and further mixed with stirring, followed by being filtered, whereby hydrophilic layer coating solutions each having a solid content of 30 weight % were prepared.

TABLE 7

| | | Hydrophilic layer | | | |
|---|---|---|---|---|---|
| | | coating solution | | | |
| Material | | 1 | 2 | 3 | 4 |
| Metal oxide | Porous aluminosilicate: JC40 | 1.50 | 2.10 | 3.00 | 1.50 |
| particles | (manufactured by Mizusawa | | | | |
| | Industrial Chemicals, Ltd., | | | | |
| | mean particle size of 4 μm) | | | | |
| Metal oxide | Dispersion 1, solid content of | 27.00 | | 24.00 | |
| particles | 50 weight % | | | | |
| having photo- | Dispersion 2, solid content of | | 24.00 | | 27.00 |
| thermal | 50 weight % | | | | |
| conversion | | | | | |
| ability | | | | | |
| Binder | Necklace form colloidal silica | 41.25 | 43.95 | 40.80 | 40.35 |
| | (alkaline type): Snowtex-PSW | | | | |
| | (manufactured by Nissan | | | | |
| | Chemical Industries, Ltd., | | | | |
| | solid content of 20 weight %) | | | | |
| | Colloidal silica (alkaline | 18.40 | 19.60 | 18.20 | 18.00 |
| | type): Snowtex-S (manufactured | | | | |
| | by Nissan Chemical Industries, | | | | |
| | Ltd., solid content of 30 | | | | |
| | weight %) | | | | |
| | Lithium silicate aqueous | 6.00 | 6.00 | 6.00 | 6.00 |
| | solution: LSS35 (manufactured | | | | |
| | by Nissan Chemical Industries, | | | | |
| | Ltd., SiO₂ content of 20 | | | | |
| | weight %) | | | | |
| Polyhydrazide | Adipic acid dihydrazide aqueous | | | 1.50 | |
| compound | solution, solid content of 10 | | | | |
| | weight % | | | | |
| | Tris(2-hydrazinocarbonylethyl)isocyanulate | | | | 3.00 |
| | aqueous solution, | | | | |
| | solid content of 10 weight % | | | | |
| surfactant | 1 weight % aqueous solution of | 3.00 | 3.00 | 3.00 | 3.00 |
| | surfactant, Surfinol 485 | | | | |
| | (manufactured by Air Products | | | | |
| | Japan Ltd.) | | | | |
| | Pure water | 2.85 | 1.35 | 3.50 | 1.15 |

Preparation of Image Forming Layer Coating Solution

Preparation of Mixture Dispersion a Comprising Wax Particles and Infrared Absorption Dye

Carnauba wax emulsion A118 (manufactured by Gifu Shellac Manufacturing Co., Ltd., mean particle size of 0.3 μm; softening point of 65° C., melting point of 80° C., melt viscosity at 140° C. of 8 cps, solid content of 40 weight %) was diluted with pure water with stirring to make a solid content of 10 weight %.

The resulting emulsion of 48.5 weight parts was titrated with 15 weight parts of 1 weight % IPA solution of infrared absorption dye 2 having the following structure over 5 minutes. The system was added with 36.5 weight parts of pure water while further continuing stirring, whereby mixed dispersion A having a solid content of 5 weight % was prepared.

Next, materials of the following table each were mixed and stirred, followed by being filtered, whereby each image forming layer coating solution (coating solutions 13-17) having a solid content of 5 weight % was prepared.

TABLE 8

| | | Coating solution | | | | |
|---|---|---|---|---|---|---|
| Material | | 13 | 14 | 15 | 16 | 17 |
| Mixture | solid content of 5 weight % | 58.00 | 55.00 | 53.00 | 53.00 | 55.00 |
| dispersion A | | | | | | |
| Polymer | Polymer particles 1, emulsion, | 3.00 | | | | |
| particles | solid content of 50 weight % | | | | | |
| | Polymer particles 2, emulsion, | | 5.83 | 5.83 | | |
| | solid content of 30 weight % | | | | | |
| | Polymer particles 7, emulsion, | | | | 5.83 | 5.00 |
| | solid content of 30 weight % | | | | | |
| Water- | Polyacrylic acid, Na aqueous | 1.00 | 0.83 | 0.83 | 1.00 | 1.33 |
| soluble | solution, Mw = 170,000, solid | | | | | |
| compound | content of 30 weight % | | | | | |
| | Guanidine phosphate, solid | 3.00 | 2.50 | 2.50 | 3.00 | 3.00 |
| | content of 10 weight % | | | | | |
| Poly- | Adipic acid dihydrazide | | | | | 0.50 |
| hydrazide | aqueous solution, solid | | | | | |
| compound | content of 10 weight % | | | | | |
| | ris(2-hydrazinocarbonylethyl)isocyanulate | | | 1.00 | | |
| | aqueous solution, | | | | | |
| | solid content of 10 weight % | | | | | |
| | Pure water | 35.00 | 35.84 | 36.84 | 37.17 | 35.17 |

Preparation of Printing Plate Materials 15-23

Hydrophilic layer coating solutions comprising combinations of Table 9 were coated on substrate 1 by use of a wired-bar, followed by being dried at 120° C. for 1 minute. The dry coating amount of the hydrophilic layer was adjusted to 4 g/m².

Next, image forming layer coating solutions of combinations of Table 9 were coated by use of a wired-bar on the hydrophilic layer, followed by being dried at 70° C. for 1 minute. The dry coating amount of an image forming layer was adjusted to 0.6 g/m².

Each sample having been coated with an image forming layer was subjected to an aging treatment at 50° C. for 24 hours to prepare printing plate materials 15-23.

With respect to each printing plate material, those to be evaluated as they are after the aging treatment, those having been kept under an environment of 55° C. and a humidity of less than 20% for 72 hours, and those having been kept under an environment of 40° C. and a humidity of 80% for 72 hours, were prepared, respectively.

[Exposure with Infrared Laser]

Each printing plate material was wound and fixed on an exposure drum. Exposure was performed by employing a laser beam having a wavelength of 830 nm and a spot diameter of 18 μm to form an image at 2,400 dpi (dpi represents a dot number per 2.54 cm) and 175 lines. The exposed image includes a solid image and a screen image of 1-99%. Exposure energy was set to 120 mJ/cm².

[Printing Method]

Printing was performed by use of press DAIYA1F-1, manufactured by Mitsubishi Heavy Industries, Ltd., and employing coated paper, damping solution: 2 weight % Astromark 3 (manufactured by Nikken Chemical Laboratory, Co., Ltd.), and ink (manufactured by Toyo Ink Mfg. Co., Ltd., TK Hy-Unity MZ Magenta).

The printing plate material after having been exposed was mounted as it is on a cylinder and 500 sheets of printing was carried out by use of a printing condition and print-start sequence similar to a PS plate.

[Evaluation of On-Press Developability]

The evaluation was made as described before. The result is shown in Table 9.

[Evaluation of Resistance Against Dirt Due to Abrasion]

The evaluation was made as described before. The result is shown in Table 9.

TABLE 9

| | | Image | | | | |
|---|---|---|---|---|---|---|
| | Hydrophilic | forming | | | Resistance | |
| Printing | layer | layer | | On-press | against | |
| plate | coating | coating | Heat | developability | dirt due | |
| material | solution | solution | storage | [number of | to | |
| No. | No. | No. | treatment | sheets] | abrasion | Remarks |
| 15 | 1 | 13 | None | 15 | A | Inv. |
| | | | 55° C. | 20 | B | |
| | | | 40° C. 80% | 15 | A | |
| 16 | 1 | 14 | None | 10 | A | Inv. |
| | | | 55° C. | 15 | A | |
| | | | 40° C. 80% | 10 | A | |
| 17 | 2 | 14 | None | 10 | A | Inv. |
| | | | 55° C. | 10 | A | |
| | | | 40° C. 80% | 10 | A | |
| 18 | 2 | 15 | None | 10 | A | Inv. |
| | | | 55° C. | 15 | A | |
| | | | 40° C. 80% | 10 | A | |
| 19 | 3 | 14 | None | 10 | A | Inv. |
| | | | 55° C. | 25 | B | |
| | | | 40° C. 80% | 20 | A | |
| 20 | 4 | 15 | None | 10 | A | Inv. |
| | | | 55° C. | 25 | B | |
| | | | 40° C. 80% | 20 | A | |
| 21 | 1 | 16 | None | 50 | B | Comp. |
| | | | 55° C. | 300 | C | |
| | | | 40° C. 80% | 200 | B | |
| 22 | 2 | 17 | None | 50 | B | Comp. |
| | | | 55° C. | 400 | C | |
| | | | 40° C. 80% | 200 | C | |
| 23 | 4 | 16 | None | 50 | B | Comp. |
| | | | 55° C. | Not less | *1 | |
| | | | | than 500 | | |
| | | | 40° C. 80% | 300 | C | |

*1: Indistinguishable due to background fogging
Inv.: This invention,
Comp.: Comparison

It is clear from Table 9 that, also in an embodiment to form a hydrophilic layer as an undercoat layer, a printing plate material of this invention is excellent in on-press developability and is provided with stable on-press developability and resistance against dirt due to abrasion even after heat storage, to exhibit excellent storage stability.

Evaluation of Printing Durability

With respect to printing plate materials 18-23 without heat storage, printing durability was evaluated in a similar manner as described before. The result is shown in Table 10.

TABLE 10

| Printing | Hydrophilic | Image forming | Printing | |
|---|---|---|---|---|
| plate | layer | layer | Durability | |
| material | coating | coating | [number of | |
| No. | solution No. | solution No. | sheets] | Remarks |
| 18 | 2 | 15 | Not less | This |
| | | | than 40000 | invention |
| 19 | 3 | 14 | Not less | This |
| | | | than 40000 | invention |
| 20 | 4 | 15 | Not less | This |
| | | | than 40000 | invention |
| 21 | 1 | 16 | 27000 | Comparison |
| 22 | 2 | 17 | 26000 | Comparison |
| 23 | 4 | 16 | 27000 | Comparison |

It is clear from Table 10 that, also in an embodiment to form a hydrophilic layer as an undercoat layer, a printing plate material of this invention is provided with sufficient printing durability.

1. A printing plate material, provided with an image forming layer on a substrate,
wherein the image forming layer contains following (A1) or (A2):
(A1) Polymer particles which are formed by emulsion polymerization utilizing polymerizable monomer having a carboxylic group and polymerizable monomer having an amide group and have a glass transition temperature (Tg) of not lower than 70° C.,
(A2) Polymer particles having a core-shell structure formed by emulsion polymerization and the shell of the polymer particles are comprised of polymer which is polymerized by use of polymerizable monomer having a carboxylic group and polymerizable monomer having an amide group and has a glass transition temperature (Tg) of not lower than 70° C.

2. The printing plate material described in claim 1,
wherein a mean particle size of the polymer particles is not less than 30 nm and less than 120 nm.

3. The printing plate material described in claim 1,
wherein the polymer particle has a carbonyl group on a surface, and the image forming layer contains (B) polyhydrazide compound.

4. The printing plate material described in claim 1,
wherein the polymer particles of (A1) and (A2) are provided with practically no styrene as a polymerizing unit.

5. A printing plate material, provided with an undercoat layer and an image forming layer on a substrate in the order from the substrate side,
wherein the image forming layer contains following (A3) or (A4) and the undercoat layer contains following (B):
(A3) Polymer particles which are formed by emulsion polymerization by use of monomer having a carbonyl group and which have a glass transition temperature (Tg) of not lower than 70° C.,
(A4) Polymer particles which are provided with a core-shell structure formed by emulsion polymerization, wherein the shell is polymerized by use of monomer having a carbonyl group and is comprised of polymer having a glass transition temperature (Tg) of not lower than 70° C.,
(B) Polyhydrazide compound.

6. The printing plate material described in claim 5,
wherein the undercoat layer is a hydrophilic layer.

7. The printing plate material described in claim 5,
wherein (B) polyhydrazide compound is water-soluble.

8. The printing plate material described in claim 5,
wherein the polymer particle having at least one group of a carboxyl group or an amide group on its surface.

9. The printing plate material described in claim 5,
wherein the polymer particles of (A3) and (A4) are provided with practically no styrene as a polymerizing unit.

10. A printing plate material, provided with an image forming layer and an overcoat layer on a substrate in the order from the substrate side,
wherein the image forming layer contains following (A3) or (A4) and the overcoat layer contains (B):
(A3) Polymer particles which are formed by emulsion polymerization by use of monomer having a carbonyl group and which have a glass transition temperature (Tg) of not lower than 70° C.,
(A4) Polymer particles which are provided with a core-shell structure formed by emulsion polymerization, wherein the shell is polymerized by use of monomer having a carbonyl group and is comprised of polymer having a glass transition temperature (Tg) of not lower than 70° C.,
(B) Polyhydrazide compound.

11. The printing plate material described in claim 10,
wherein the polymer particle having at least one group of a carboxyl group and an amide group on its surface.

12. The printing plate material described in claim 10,
wherein the polymer particles of (A3) and (A4) are provided with practically no styrene as a polymerizing unit.
